(19) United States
(12) Patent Application Publication
(10) Pub. No.: US 2006/0242817 A1
(43) Pub. Date: Nov. 2, 2006

(54) Component with a pressed on pressure element as well as a pressure element and method for pressing on a pressure element

(75) Inventors: Klaus Dehlke, Windsbach (DE); Peter Strempel, Schwabach (DE)

Correspondence Address: LERNER GREENBERG STEMER LLP, P O BOX 2480, HOLLYWOOD, FL, 33022-2480, US

(73) Assignee: Richard Bergner Verbindungstechnik GmbH & Co. KG

(21) Appl. No.: 11/115,892

(22) Filed: Apr. 27, 2005

(51) Int. Cl. B23P 11/00; F16B 39/20

(52) U.S. Cl. 29/525.02; 411/87

(57) ABSTRACT

To form a pressed connection between a component (6) and a press-in nut (2), the latter has a deformation region (16) which is pressed into a wall (20) of a hole (4) in the component (6) by a suitably formed die (22) during the press-in operation. As a result, a form fit is formed which is effective in two directions and provides for a reliable hold of the press-in nut. The press-in nut (2) is suitable in particular for fastening in thick components (6) and is largely independent of the component thickness (D).

The invention relates to a component, in particular a metal sheet, having a press-in element, in particular a press-in nut, pressed into a hole of the sheet. The invention also relates to such a press-in element and to a method of pressing the press-in element into the component.

A press-in nut serves for forming a screw fastening means on a thin-walled component, such as a metal sheet for example. To this end, it is pressed into the sheet and held therein in a form-fitting manner. It normally has an internal thread, into which a screw can be screwed. As an alternative to the configuration as a press-in nut, “press-in studs” are also know as press-in elements, which differ from the press-in nut essentially by a stud provided, for example, with an external thread and integrally formed in a fixed manner. The press-in element normally has a head part with a web integrally formed on its underside. The web may also be designated as flange or collar. When being pressed in, the press-in element is inserted with the web into a hole of the component and, with the head part, bears like a shoulder on the hole margin. Provided as anti-rotation protection is, for example, a web of non-circular design and having edges. Radially integrally formed ribs may also be formed as anti-rotation protection on the underside of the head part, these ribs being pressed into the sheet during the setting.

Different methods are known in order to form the form-fitting connection during the setting operation, in order thus to secure the press-in element against falling out.

Thus, for example, the procedure is often for the web height of the press-in nut to exceed the component thickness and for the projecting portion of the web to be bent over, so that the component is clamped in place between the head part of the press-in nut and the bent-over section of the web. However, such press-in nuts with a bent-over margin only lead to unsatisfactory results in the case of thick sheets. The expression “thick sheets” in this case refers to sheets having a sheet thickness greater than 2.5 mm and in particular also greater than 3.5 mm.

WO 82/02579 discloses a press-in nut in which a web is incorporated in an annular groove below the head part. During the press-in operation, material of the sheet is pressed into this groove by cold working as a result of a corresponding configuration of the underside of the head part. DE 29 20 211 A1 discloses a similar principle, the web here being designed like a dovetail and forming an undercut with the head part, into which undercut material is again pressed by shaping of the sheet during the setting operation.

DE 28 18 756 A1 discloses a press-in or threaded nut in which the web or flange adjoining the underside of the head part has a height corresponding to the component thickness. The flange forms an obtuse cone angle by upsetting during the setting operation, as a result of which, on the one hand, the flange forms an undercut with the head part and, on the other hand, sheet material is enclosed in this undercut.

The object of the present invention is to ensure simple and reliable fastening of a press-in element, in particular a press-in nut, also in thick components.

This object is achieved according to the invention by a component having the features as claimed in claim 1.

The component has a press-in element, in particular a press-in nut, pressed into a hole and having a head part and an adjoining web. Now it is essential that the height of the web is less than and thus independent of the component thickness, and that a deformation region of the web is provided. This deformation region is shaped and pressed into the hole wall during the setting operation.

This configuration has the decisive advantage that, to form a form-fitting connection between the press-in nut and the component, it is not the component that is deformed but only the web, which is pressed into or cuts into the component. In the press-in region, only a displacement of the component material takes place. In the set final state, the pressed-in deformation region is completely surrounded by the material of the component due to the pressing into the hole wall. As a result, the press-in nut is held in an especially reliable and lasting manner. A form fit acting in two axial directions is formed between the web and the component material. The complete enclosure of the deformation region rules out the possibility of the bent-over deformation region giving way again slightly, as a result of which the reliable seating would be impaired.

A further substantial advantage can be seen in the fact that such a press-in nut is largely independent of the component thickness, since the extent to which the component thickness exceeds the height of the web is of no importance for the firm seating. The press-in nut can therefore be used universally for widely differing component thicknesses, and different press-in nuts need not be produced and kept in stock for different thicknesses.

Furthermore, such a press-in nut is simple to realize from the production point of view, since no special measures for forming an undercut, for example, have to be taken during the production. The processing, that is to say the pressing of the press-in nut into the component, can also be carried out without any problems and in a simple manner on account of merely a single-stage setting operation.

According to an expedient development, the web has a shank region which extends into the hole and preferably runs parallel to the hole wall and adjoining which is the deformation region. In this case, the outside diameter of the shank region corresponds in particular to the inside diameter of the hole. As a result, the shank region, even in the set state, forms a type of sleeve and thereby provides especially good seating of the press-in nut in the hole. The sleeve formed by the shank region also provides for especially good guidance of a screw which is screwed, for example, into the press-in nut. Due to the configuration with the undeformed shank region and the shaped deformation region, the web is therefore shaped only in one section.

In this case, the shank region expediently has an internal thread having in particular a plurality of thread turns. By means of this measure, a comparatively elongated thread region and thus a reliable hold of a screw are achieved.

With regard to a simple setting operation, the deformation region, on the inside at the end, has a bevel designed in particular like a conical taper. During the setting, this bevel interacts with a die head of a die, the die head preferably being designed to be complementary to the bevel of the deformation region.

The object is also achieved according to the invention by a press-in element having the features of patent claim 5, this press-in element having a head part and an adjoining web with a shank region and an adjoining deformation region, only the deformation region being provided for the radial widening.

Preferred configurations of the press-in element can be gathered from the subclaims. The advantages cited with regard to the component with pressed-in press-in element and preferred configurations can accordingly be applied to the press-in element.

According to a preferred configuration, provision is made in particular in this case for the outer wall of the web, in the unfitted state, to be oriented perpendicularly or with an obtuse angle being enclosed with the underside of the head part. With regard to the wall of the hole, the web, in the state in which it is not set, therefore runs parallel to the hole wall or, for forming an insertion bevel, slightly inclined relative to the hole wall. No undercut is formed between the web and the underside of the head part. The outside diameter of the web, or the largest outside diameter in the case of the inclined configuration, preferably corresponds to the inside diameter of the hole, except for a necessary tolerance margin. The press-in element has a sleeve-like web which is simple to produce and has a shank region and a deformation region with smooth outer wall and without grooves or the like.

Furthermore, according to an expedient configuration, a locking web is provided which is arranged on the underside of the head part at a radial distance from the web. The locking web is likewise preferably of annular design and is arranged in particular as a marginal web on the outer margin of the head part. Due to the arrangement of the locking web, the set press-in element withstands higher press-out forces. This is because, when a force acts in the opposite direction to the setting direction, the press-in element is braced in the component by the interaction between the web, molded into the hole wall after the setting operation, and the locking web pressed into the component surface.

At least one recess, preferably a plurality of recesses are preferably arranged on the bottom front end of the web. Since the front end projects into the material in the set state, this configuration results in a form fit which acts in the peripheral direction and forms an anti-rotation locking means for the press-in element pressed into the hole.

The deformation region, at least in the transition region to the shank region, has a reduced wall thickness in comparison with the shank region. As a result, the deformation region can be bent over in a defined manner in the transition region to the shank region. The reduced wall thickness may also be formed by a notch, which defines a predetermined bending point.

The object is also achieved according to the invention by a method of pressing a press-in element into a component. In this case, the procedure is such that the press-in element is inserted with its web into a hole of the component, the component having a component thickness exceeding the height of the web. A die with a tapering die head is inserted from the underside of the component. When the press-in nut is being pressed in, the web is deformed outward in its deformation region on account of the tapering die head and is thereby pressed into the hole wall of the component, to be precise in such a way that the pressed-in section of the web is completely surrounded by the material of the component. In this case, the pressing into the hole wall is ensured in particular by the die head, which projects into the hole and is designed in particular like a cylinder.

For an especially cost-effective and simple setting operation, the press-in element is preferably pressed into the component in a single-stage setting operation. Here, the expression “single-stage” refers to the fact that the insertion of the press-in element into the hole and also the fastening in the hole, in particular the spreading of the deformation region into the hole wall, take place within a working cycle. In particular, the fastening is effected at the same time as the insertion; i.e., during the insertion into the hole, the deformation region is spread out at the same time and thus the press-in element is fastened. At the end of the insertion operation, the fastening has also been completed.

In order to achieve the desired widening of the web, the die preferably has a conical or frustoconical or rounded die head. Due to this configuration, the web, during the setting operation, in which the press-in nut is increasingly displaced against the die, is gradually deformed and pressed into the hole wall. In this case, it is especially advantageous if the die head has an outer surface adapted to the bevel of the web. In particular, the die therefore has a conical taper complementary to the bevel of the web, i.e. the cone angle of the beveled deformation region and that of the die head correspond to one another.

In order to widen the web in the deformation region to the greatest possible extent, the die, in an expedient configuration, has a shank with an outside diameter which is adapted to the hole radius and with which it projects into the hole during the press-in operation. Therefore, except for a necessary tolerance margin, the shank sits in the hole in an accurately fitting manner, so that the die is guided by the hole.

In order to ensure that only a section of the web is deformed and that an internal thread arranged on the inside in the shank region of the web remains undamaged, the die is preferably inserted only partly into the hole during the setting operation.

Exemplary embodiments of the invention are explained below with reference to the figures. In the drawing, in each case in schematic and greatly simplified illustrations:

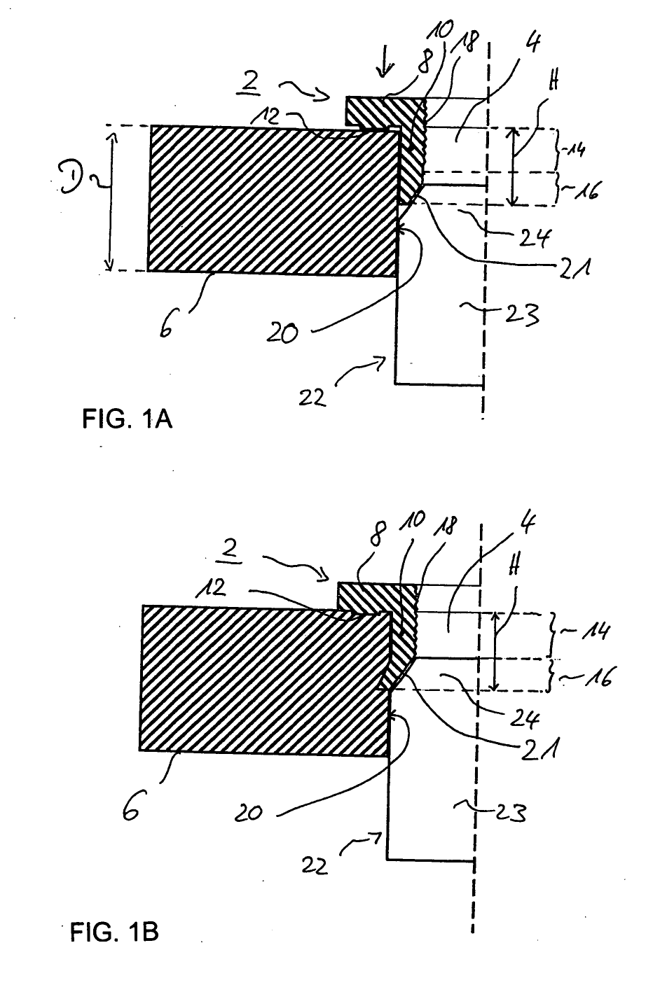

FIG. 1A shows a detailed illustration of a press-in element inserted into a hole of a component and also a die, partly inserted into the hole, of a setting tool at the start of the setting operation,

FIG. 1B shows the illustration according to FIG. 1A at the end of the setting operation,

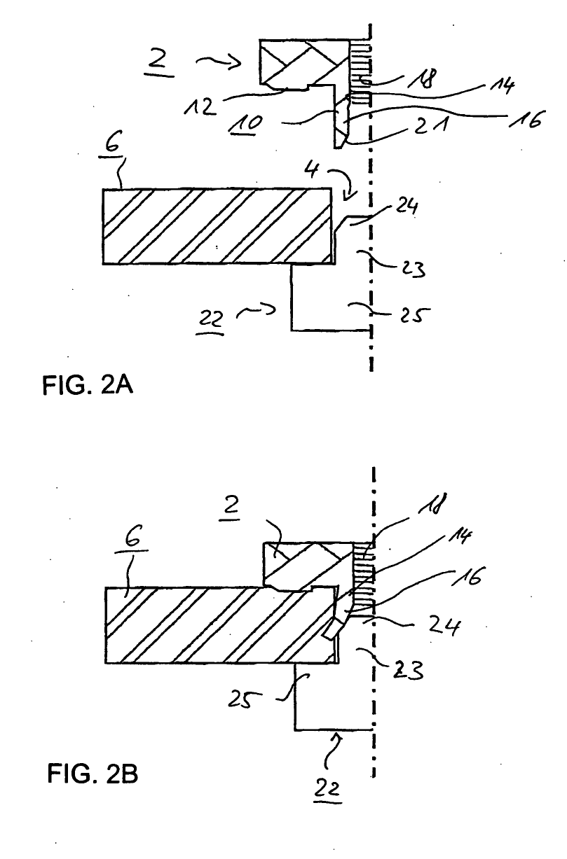

FIGS. 2A, 2B show a modified configuration of the variant according to FIGS. 1A, 1B,

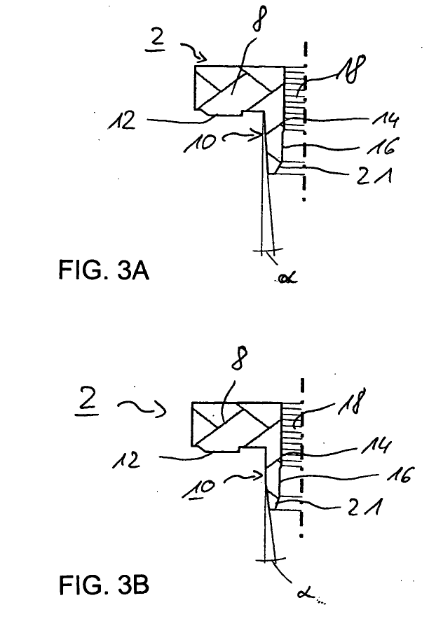

FIGS. 3A, 3B shows a detailed illustration of a press-in element with an inclined or partly inclined outer wall of the web,

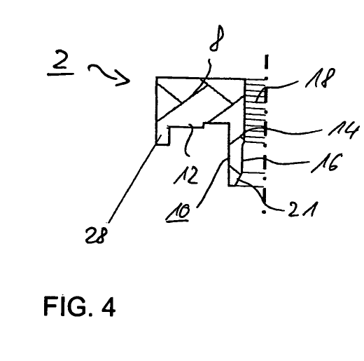

FIG. 4 shows a detailed illustration of a press-in element with a locking web, and

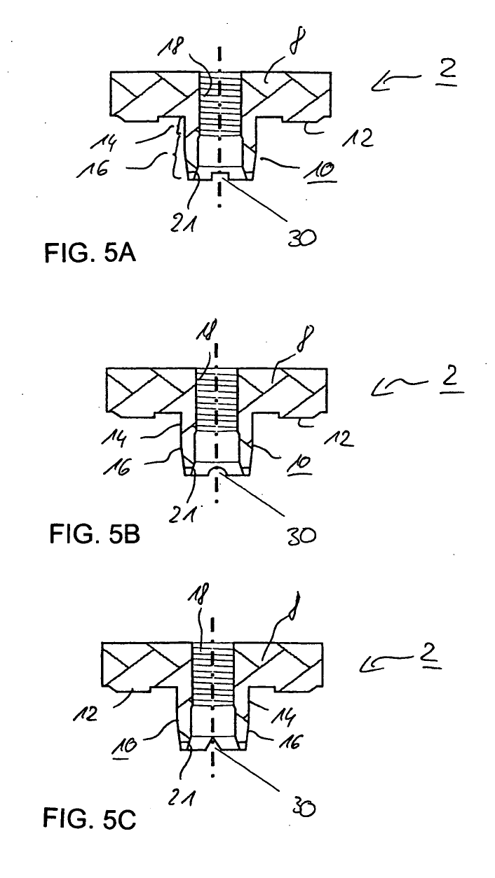

FIGS. 5A-5C each show a press-in element with a front-end recess on the web in different embodiments.

FIGS. 1A to 4 each show only one symmetrical half of the arrangement or of the press-in element in a sectional view. The symmetry axis is shown by the broken line. According to FIGS. 1A to 2b, an, in particular circular, press-in element designed as press-in nut 2 and rotationally symmetrical to the symmetry axis is inserted into a hole 4 of a component 6. The component 6 has a component thickness D which is preferably greater than 2.5 mm and in particular greater than 3.5 mm. The component 6 is in particular a metal sheet.

The press-in nut 2 has a head part 8, adjoining which is a web 10. The head part 8 and web 10 are therefore formed roughly like an L. Furthermore, a plurality of radially running ribs 12 are provided on the underside of the head part 8 in such a way as to be distributed over the periphery, these ribs 12 acting as anti-rotation protection in the set state. The web 10 comprises a shank region 14, which adjoins the head part 8 and adjoining which in turn is a deformation region 16. According to the variant according to FIGS. 2A and 2B, the deformation region 16 has a smaller wall thickness than the shank region 14. The web 10 has an overall height H which is less than the component thickness D. An internal thread 18 having a plurality of turns is provided on the inside of both the head part 8 and the shank region 14. On its inside, the deformation region 16 is designed to be tapered toward its end remote from the head part 8 and has a bevel 21. The press-in nut 2 therefore has a frustoconical receptacle or taper on its underside. The outside of the web 10 runs parallel to the wall 20 of the hole 4. The outside diameter of the web 10 corresponds essentially to the diameter of the hole 4.

In the region of its head, the press-in nut 2 has a larger outside diameter than the hole diameter, so that the head part 8 overlaps the hole 4, and the press-in nut 2, with the head part 8, comes to bear on the top side of the component 6.

A die 22 is provided for the press-in operation, a cylindrical shank 23 of this die 22 being inserted into the hole 4 from below in at least approximately accurately fitting manner. At its front end adjoining the shank 23, the die 22 has a die head 24, which tapers conically like a frustum of a cone. In this case, the frustum angle is selected in such a way that the outer surface of the die head 24 runs approximately parallel to the bevel 19 of the deformation region 16.

In the exemplary embodiment in FIGS. 2A, 2B, the die 22 has a base part 25 widened relative to the shank 23, so that a bearing surface projecting beyond the hole margin is formed, with which bearing surface the die 22 is supported on the underside of the component 6 during the setting operation. This limits and establishes the penetration depth of the shank 23 into the hole 4. The location at which the web 10 is pressed into the hole wall is thus also established at the same time.

To press the press-in nut 2 into the component 6, the press-in nut 2 is inserted with its web 10 into the hole 4 and sits there at first largely free of play. A press-in force is then exerted on the head part 8 in the arrow direction by a setting tool (not shown here). At the same time, the die 22 is inserted into the hole 4 from below. At the start of the setting operation, the bevel 19 and the outer surfaces of the die head 24 bear approximately flush against one another. The press-in nut is increasingly pressed against the die 22 in the arrow direction. As a result, the deformation region 16 is bent outward into the hole wall 20, so that the deformation region 16 cuts into the material of the component 6. In the process, the press-in nut 2 is pressed in until the underside of its head part 8 bears flush against the surface of the component 6. In this final state, the ribs 12 are molded into the component 6. As can be seen from FIGS. 1A to 2B, the press-in nut 2 is fastened in a single-stage setting operation, in which the insertion of the press-in nut 2 into the hole 4 and its fastening therein are effected at the same time.

In the set final state, as can be seen from FIGS. 1B, 2B, the deformation region 16 therefore penetrates with its tip into the component 6 and is completely enclosed by the material of the component 6. The deformation region 16 therefore forms a form fit acting in both axial directions and thus provides for especially reliable seating. Furthermore, a recessed portion or notch (not shown) can be provided on the outside, oriented relative to the hole wall 20, of the deformation region 16, so that material of the component 6 is pressed into this notch in the set state and forms a type of barb for additional retention.

In the configuration according to FIG. 3A, the outer wall of the web 10 encloses an acute angle α with the perpendicular, which is about 5° in the exemplary embodiment, so that an insertion bevel is formed which permits easy insertion and centering of the press-in nut 2. The outer wall therefore encloses an obtuse angle (90°+α) with the underside of the head part 8. In contrast thereto, the insertion bevel in the exemplary embodiment according to FIG. 3B is formed only in the front-end region of the web 10.

An embodiment having a locking web 28 running around the margin on underside of the head part 8 is shown in FIG. 4. During the setting operation, this locking web 28 is pressed into the top side of the component 6. The press-out force required for (undesirable) slipping out of the hole 4 is increased by this locking web 28. This is because, when a press-out force acts against the setting direction, the press-in nut is braced in the component 6 on account of the interaction between the locking web 28 and the web 10 pressed into the hole wall.

According to the embodiment variants in FIGS. 5A to 5C, the web 10 has recesses 30 at its front end. A plurality of these recesses 30 are preferably arranged in a distributed manner over the periphery of the front end in particular at uniform distances apart. In the pressed-in state, these recesses 30 form with the material of the component 6 a form fit acting in the peripheral direction, so that an anti-rotation locking means is formed and rotation of the set press-in nut 2 in the component 6 is avoided. In this case, the geometry of the recessed surface is, for example, rectangular (FIG. 5A), semicircular (FIG. 5B) or triangular (FIG. 5C).

With press-in nuts 2 described here, with their various embodiment variants, especially reliable fastening of the press-in nut 2 in the hole 4 of the component 6 is made possible by a simple single-stage setting operation. No shaping of the component 6 is required for this purpose. On the contrary, a form fit is formed by virtue of the fact that part of the press-in nut 2, namely part of the deformation region 16, is pressed into or cuts into the hole wall 20 and merely displaces material of the component 6 there. Such a press-in nut 2 is especially suitable for use in thick sheets, since, apart from the reliable fastening, it can be used universally for components having different component thicknesses.

### LIST OF DESIGNATIONS

2 Press-in nut
4 Hole
6 Component
8 Head part
10 Web
12 Rib
14 Shank region
16 Deformation region
18 Internal thread
20 Hole wall
21 Bevel
22 Die
23 Shank
24 Die head
25 Base part
28 Locking web
30 Recess
D Component thickness
H Height
α Angle

1-18. (canceled)

19. A component, comprising:
a component body having a given thickness and a hole formed therein defined by a hole wall; and
a press-in element pressed into said hole of said component body, said press-in element having a head part projecting beyond said hole and a web projecting from an underside of said head part, said web having a height being less than said given thickness, said web further having a deformation region being pressed into said hole wall by shaping during a setting operation.

20. The component according to claim 19, wherein said web has a shank region extending into said hole and running parallel to said hole wall, said shank region adjoining said deformation region.

21. The component according to claim 20, wherein said web, in said shank region, has an internal thread having a plurality of thread turns.

22. The component according to claim 19, wherein said web has a bevel on an inside at an end in said deformation region.

23. The component according to claim 19, wherein said press-in element is a press-in nut.

24. The component according to claim 19, wherein said web is an annular web.

25. A press-in element for pressing into a component having a hole formed therein, the press-in element comprising:
a head part bearing on the component in a pressed-in state and having an underside; and
a web extending from said underside of said head part, said web having a shank region and an adjoining deformation region, said deformation region being provided for a radial widening.

26. The press-in element according to claim 25, wherein said web has a height being less than a given thickness of the component.

27. The press-in element according to claim 25, wherein said web has an outer wall oriented perpendicularly or with an obtuse angle being at least partly enclosed with said underside of said head part.

28. The press-in element according to claim 25, wherein said web, in said shank region, has an internal thread with a plurality of thread turns.

29. The press-in element according to claim 25, wherein said web has a bevel on an inside at an end in said deformation region.

30. The press-in element according to claim 25, further comprising a locking web disposed at a distance from said web and running around a margin disposed on said underside of said head part.

31. The press-in element according to claim 25, wherein said web has at least one recess formed therein at a front end.

32. The press-in element according to claim 25, wherein said deformation region has a transition region extending to said shank region, said transition region having a reduced wall thickness in comparison with said shank region.

33. The component according to claim 25, wherein said press-in element is a press-in nut.

34. The component according to claim 25, wherein said web is an annular web.

35. A method of pressing a press-in element into a component, the press-in element containing a head part and a web extending from an underside of the head part, the component having a hole formed therein for receiving the press-in element and a given thickness exceeding a height of the web, which comprises the steps of:
inserting a die having a tapering die head into the hole of the component, the die head provided for shaping at least a section of the web radially outward; and
pressing the section of the web into a hole wall of the component.

36. The method according to claim 35, which further comprises pressing the press-in element into the component in a single-stage setting operation.

37. The method according to claim 35, which further comprises forming the die head as a conical, frustoconical, or rounded die head.

38. The method according to claim 35, which further comprises forming the web with a bevel on an inside at an end, the bevel and an outer surface of the die head being adapted to one another and running parallel to one another.

39. The method according to claim 35, which further comprises forming the die with a shank having an outside diameter adapted to a hole radius of the hole, and the shank projects into the hole.

40. The method according to claim 38, which further comprises inserting the die only partly into the hole, so that a shank region of the web remains undeformed.

41. The method according to claim 35, which further comprises forming the press-in element as a press-in nut.

42. The method according to claim 35, which further comprises forming web as an annular web.
